(19) United States
(12) Patent Application Publication
(10) Pub. No.: US 2023/0252733 A1
(43) Pub. Date: Aug. 10, 2023

(54) DISPLAYING BLOCKCHAIN DATA ASSOCIATED WITH A THREE-DIMENSIONAL DIGITAL OBJECT

(71) Applicant: Anima Virtuality, Inc., Newtown, PA (US)

(72) Inventors: Alexander Robert HERRITY, Newtown, PA (US); Neil Daniel VOSS, Norwalk, CT (US)

(73) Assignee: Anima Virtuality, Inc., Newtown, PA (US)

(21) Appl. No.: 18/055,318

(22) Filed: Nov. 14, 2022

Related U.S. Application Data
(60) Provisional application No. 63/264,085, filed on Nov. 15, 2021.

(51) Int. Cl. G06T 19/00; H04L 9/32

(52) U.S. Cl. CPC G06T 19/006; H04L 9/3263

(57) ABSTRACT

In a computer-implemented method for displaying blockchain data associated with a three-dimensional digital object, a three-dimensional digital object is registered with an application for monitoring blockchain events corresponding to an update event for the three-dimensional digital object. The blockchain events are monitored for an event corresponding to an update event for the three-dimensional digital object. Responsive to detecting the update event, it is determined that the metadata for the three-dimensional digital object comprises stale data. The metadata is updated to replace the stale data with current data. The three-dimensional digital object is displayed within a presentation medium. Responsive to detecting a first interaction with the three-dimensional digital object within the presentation medium, a certificate object is displayed within the presentation medium, the certificate object comprising the current data.

### RELATED APPLICATION

This application claims priority to and the benefit of co-pending U.S. Provisional Patent Application 63/264,085, filed on Nov. 15, 2021, entitled “DISPLAYING BLOCKCHAIN DATA ASSOCIATED WITH A THREE-DIMENSIONAL DIGITAL OBJECT,” by Herrity, et al., having Attorney Docket No. ANIMA-001.PRO, and assigned to the assignee of the present application, which is incorporated herein by reference in its entirety

### BACKGROUND

Non-fungible tokens (NFTs) are increasing in prevalence as means for certifying proof of ownership of digital objects. NFTs, such as pieces of digital art, have associated metadata that may include information such as the creator of the digital object, the title of the digital object, the current owner of the digital object, etc. Using conventional technology, where the NFT is capable of display within a particular presentation medium, such as a virtual three-dimensional space or augmented reality (AR), viewing the associated metadata requires use of a viewing application other than the presentation medium, pulling the viewer out of the visual experience, as well as requiring additional applications and means for executing such additional application.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 is a block diagram illustrating a system for displaying blockchain data associated with a three-dimensional digital object, in accordance with embodiments.

FIG. 2 is a screen shot illustrating an example digital object and corresponding blockchain-certified digital object metadata represented within augment reality (AR), in accordance with embodiments.

FIG. 3 is a screen shot illustrating an example digital object and corresponding blockchain-certified digital object metadata represented within a virtual three-dimensional space, in accordance with embodiments.

FIG. 4 is a block diagram of an example computer system upon which embodiments of the present invention can be implemented.

FIG. 5 is a block diagram of an example mobile electronic device upon which embodiments of the present invention can be implemented.

FIG. 6 is a flow diagram of example operations for displaying blockchain data associated with a three-dimensional digital object, according to various embodiments.

### DESCRIPTION OF EMBODIMENTS

Reference will now be made in detail to various embodiments of the subject matter, examples of which are illustrated in the accompanying drawings. While various embodiments are discussed herein, it will be understood that they are not intended to be limited to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments. As denoted elsewhere herein, like element numbers are intended to indicate like elements or features.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “registering,” “monitoring,” “detecting,” “determining,” “generating,” “updating,” “displaying,” “presenting,” “storing,” “applying,” “retrieving,” “populating,” “accessing,” or the like, refer to the actions and processes of an electronic computing device or system such as: a host processor, a processor, a memory, a cloud-computing environment, a system manager, a computer system of a distributed computing system, or the like, or a combination thereof. The electronic device manipulates and transforms data represented as physical (electronic and/or magnetic) quantities within the electronic device's registers and memories into other data similarly represented as physical quantities within the electronic device's memories or registers or other such information storage, transmission, processing, or display components.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example mobile electronic device described herein may include components other than those shown, including well-known components.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### Overview of Discussion

Example embodiments described herein improve the performance of computer systems by displaying blockchain data associated with a three-dimensional digital object within the presentation medium displaying the three-dimensional digital object.

Non-fungible tokens (NFTs) are used for certifying proof of ownership of digital objects. NFTs, such as pieces of digital art, have associated metadata that may include information such as the creator of the digital object, the title of the digital object, the current owner of the digital object, etc. Certain types of three-dimensional digital objects that are NFTs are configured for display within particular presentation mediums that represent three-dimensional space. For example, some three-dimensional digital objects can be displayed within a virtual three-dimensional environment. In other embodiments, some three-dimensional digital objects can be displayed within augmented reality (AR), where an application on a mobile device (e.g., a mobile phone or an augmented or virtual reality headset) displays digital objects within a visualization of the actual physical world as captured through a camera.

Using conventional technology, where the NFT is capable of display within a particular presentation medium, such as a virtual three-dimensional space or AR, viewing the associated metadata requires use of a viewing application other than the presentation medium, pulling the viewer out of the visual experience, as well as requiring additional applications and means for executing such additional application. For example, in the conventional technology, a user wishing to access authorship or ownership information associated with an NFT for a digital object must identify the token and use a viewing application, such as a web browser, to access and view this information. This may further require access to a second electronic device, or require the closing of the application hosting the presentation medium, to view this information.

Embodiments described herein provide methods and systems for synchronizing, authenticating, and displaying blockchain-based certified ownership and other object metadata upon virtual objects within the presentation medium displaying the virtual object (e.g., AR or other forms of three-dimensional virtual representation).

Embodiments described herein provide a computer-implemented method for displaying blockchain data associated with a three-dimensional digital object. A three-dimensional digital object is registered with an application for monitoring blockchain events corresponding to an update event (e.g., a transfer event) for the three-dimensional digital object, wherein the three-dimensional digital object has corresponding metadata of the three-dimensional digital object. In some embodiments, the metadata further includes at least one of: ownership information, authorship identification, a blockchain address, a title, an edition number, a resource locator for linking to an origin point, attributes of the NFT, and three-dimensional coordinates of voxels.

The blockchain events are monitored for corresponding to an update event (e.g., a transfer event) for the three-dimensional digital object, where an update event indicates that the metadata for the three-dimensional object has changed. For example, an update event can be a transfer event such as a change in ownership, a transfer of the NFT to a different wallet, or a request from another service to change the metadata associated with the NFT. Responsive to detecting an update event for the three-dimensional digital object, it is determined that the metadata for the three-dimensional digital object comprises stale data. Responsive to determining that the metadata for the three-dimensional digital object is stale, the metadata is updated to replace the stale data with current data. In some embodiments, where the update event is a transfer event, responsive to detecting a transfer event for the three-dimensional digital object, it is determined that the metadata for the three-dimensional digital object comprises stale data. In such embodiments, responsive to determining that the ownership information of the metadata for the three-dimensional digital object is stale, the metadata is updated to replace the stale data with current data such that at least the ownership information is updated. Other examples of update events include, but are not limited to, attribute changes to the metadata stored on or linked to the three-dimensional digital object itself such as the color of the three-dimensional digital object, the size of the three-dimensional digital object, etc.

The three-dimensional digital object is displayed within a presentation medium. In some embodiments, the presentation medium includes one of an augmented reality medium and a virtual three-dimensional medium. Responsive to detecting a first interaction with the three-dimensional digital object within the presentation medium, a certificate object is displayed within the presentation medium, the certificate object including the current data. In some embodiments, the method further includes accessing a resource associated with the resource locator for displaying the origin point responsive to detecting a second interaction with resource locator for linking to an origin point of the certificate object within the presentation medium.

In some embodiments, the three-dimensional digital object is comprised of a monolithic data format. In some embodiments, the updating the metadata to replace the stale data with current data includes generating the certificate object using the metadata comprising the current data. The certificate object is stored for retrieval. In some embodiments, displaying a certificate object within the presentation medium includes retrieving the certificate object.

In some embodiments, the three-dimensional digital object is comprised of a dynamic data format. In some embodiments, the updating the metadata to replace the stale data with current data includes storing the metadata comprising the current data. In some embodiments, the displaying a certificate object within the presentation medium includes retrieving the metadata comprising the current data. A certificate object template is displayed within the presentation medium. The certificate object template is populated with the metadata including the current data.

Hence, the embodiments of the present invention greatly extend beyond conventional methods of visualizing blockchain-certified digital object metadata, such as ownership information. For instance, presenting a visualization of blockchain-certified digital object metadata within a presentation medium displaying the digital object allows for contemporaneous viewing of the current metadata without requiring the use of additional applications and/or electronic devices, thereby reducing computing resource usage. Accordingly, embodiments of the present invention amount to significantly more than merely using a computer to visualize blockchain-certified digital object metadata. Instead, embodiments of the present invention specifically recite a novel process, rooted in computer technology, for presenting a visualization of the current state of the blockchain-certified digital object metadata for a digital object within the presentation medium displaying the digital object, improving the user experience and improving performance of the underlying computer system.

### Example System for Displaying Blockchain Data Associated with a Three-Dimensional Digital Object

Embodiments herein provide means of synchronizing, authenticating, and displaying blockchain-based certified ownership and other object metadata upon virtual objects in augmented reality or other forms of 3D virtual representation. Three-dimensional digital objects that can be represented in AR or other three-dimensional virtual representations are created and available for transfer between owners using blockchain (e.g., in response to a sale). Each three-dimensional digital object, when viewed, includes a tap-to-view certificate that presents the blockchain-backed certification metadata of that discreet object (e.g., the artist and release information, the current owner, and metadata about the edition itself (which number it is, how many there are, etc.))

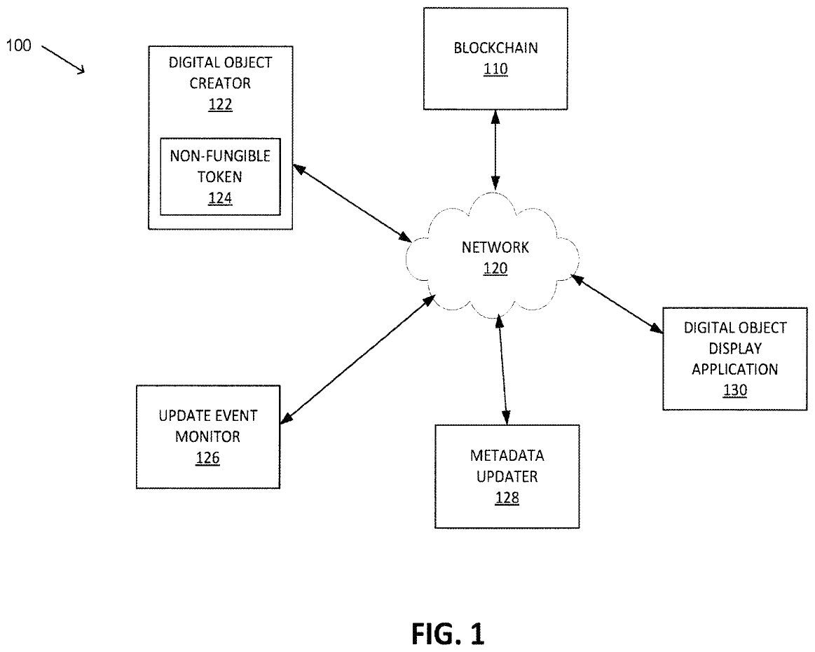

FIG. 1 is a block diagram illustrating a system 100 for displaying blockchain data associated with a three-dimensional digital object, in accordance with embodiments. System 100 includes blockchain 110, network 120, digital object creator 122, update event monitor 126, metadata updater 128, and digital object display application 130.

At digital object creator 122, a digital object is created. In some embodiments, digital object creator 122 includes a marketplace for buying and selling digital objects. Upon creation, the digital objects are added to blockchain 110 using non-fungible tokens 124, where blockchain 110 is a distributed digital ledger of transactions for registered digital objects. Digital objects sold as NFTs include blockchain-backed certification metadata. The metadata embodying the object is reflected in the certificate, where the metadata may include, in accordance with various embodiments and without limitation:
The artist or creator of the object (e.g., its maker);
The title or edition naming of the object;
The blockchain ID of the smart contract from which the object was minted/originated on chain;
The current owner of the edition, reflecting who currently owns the NFT on chain (e.g., a token representing the person(s) or organization(s) having control of the blockchain public key currently ‘owning’ the NFT);
The edition number—in the case of a numbered edition, or the ‘token ID’ of the on-chain token. This number is always unique, per object, regardless of supply limits;
The total supply—in the case of a limited edition, or the nature of supply (if the edition does not have a cap it would replace this with ‘unlimited edition’ or something signifying such);
Metadata reflecting on-chain ‘attributes’ of the token. For example, a material ‘rarity’ could be derived from something like ‘which hat the virtual cat has’ which was randomly determined when minted. The corresponding attribute/s key/values, when applicable, are displayed;
Attribute information for actions taken in response to events that take place in the real world and AR (e.g., bringing the NFT to a specific location) that can change the attributes (e.g., appearance) of the NFT when detected; and
A resource locator (e.g., a QR code or a uniform resource locator (URL)) linking to the base URL of the object—the origin point from which it was sold (e.g., the marketplace). This is consistent with the NFT metadata standard field ‘external_url’.

Update event monitor 126 is configured to monitor the blockchain for blockchain events corresponding to updates to the metadata of the three-dimensional digital object, where an update event indicates that the metadata for the three-dimensional object has changed (e.g., a transfer event for the three-dimensional digital object). For example, an update event can be a transfer event such as a change in ownership, a transfer of the NFT to a different wallet, or a request from another service to change the metadata associated with the NFT. For instance, update event monitor 126 monitors for blockchain events including the creation of a token or the transfer (sale, exchange, cross-chain bridging, or deletion/burning) of a token, and uses these events to determine the state of the certificate.

Metadata update 128 is configured to update the metadata to replace the stale data with current data. For example, where the update event is a transfer event, metadata update 128 is configured to update the metadata such that at least the ownership information is updated. Different rendering context provide different levels of support for dynamic content viewing. Some digital object and certificate object formats are monolithic (e.g., static)—a user downloads and views a file in AR but their viewer does not allow that file to connect to a server or otherwise load and process external data. For example: native ‘USDZ’ viewing AR on iOS in Apple's Quick Look, or social platforms like Snapchat and Instagram AR lenses.

Some digital object and certificate object formats are dynamic—a user is running a real time AR experience that can in turn fetch, process, and display external data. In some embodiments, a thin App Clip client or a web-based AR experience is used to show AR, which can query information from API endpoints, others, or blockchains to display.

Synchronization works such that for monolithic files, metadata updater 128 generates all the corresponding changes to the certificate view (text and graphical changes) on a rendering server, and uploads the changed assets to the cloud data store/s in place of the old NFT metadata.

For dynamic files, metadata updater 128 updates a database reflection of the on-chain data, and in turn dynamic applications can use a web API to query and display the correct and current metadata in a dynamic view at time-of-viewing. It should be appreciated that the caching and returning of this information via API is not required, as the certificate could load the metadata directly from the on-chain metadata, but the caching of and returning of this information via the API affords some performance advantages.

Digital object display application 130 is configured to display the digital object and display a certificate object including the current state of the metadata within a presentation medium (e.g., AR or other three-dimensional virtual space). Information of the metadata is presented this information within a certificate object within the presentation medium where the digital object itself is displayed. In some embodiments, the certificated object is represented as a card displayed within the presentation medium proximate the digital object. For example, the certificate object is retrievable by a user through a simple interaction (e.g., tapping on the object itself). In some embodiments, interacting with the certificate object card can be used to take the user to the base URL (external_url) of the marketplace (e.g., the origin point of the digital object), so they may act upon functions like buying, making an offer to buy, managing their own objects, bookmarking, etc.

In some embodiments, the certificate object includes a resource locator for the origin point. Since the digital objects are intended for a camera-based context (people will view them in AR, and record and share media of them), it is desirable to maintain a linkage between recorded media and the actual object or origin URL. For example, the resource locator includes a QR code on the certificate object allowing a user recording media of the digital object can include its display. Others who see that media online in non-dynamic formats, for example, shared in a tweet, can scan it with a QR-capable camera and be linked directly from the recorded media to the marketplace and/or directly into the AR context themself.

In some embodiments, the certificate object allows owners to prove they own an object for which they recorded media. For instance, the certificate object elevates the authenticity info from the blockchain into the apparatus by which they share and communicate ownership: posts, messages, social networks, etc. This is critical in the context of virtual worlds: digital things can be immediately replicated but blockchain certification does not lie. Showing a certificate with blockchain data can prove ownership. Fake certificates can easily be ruled out when the information they present is not valid when compared to on-chain data.

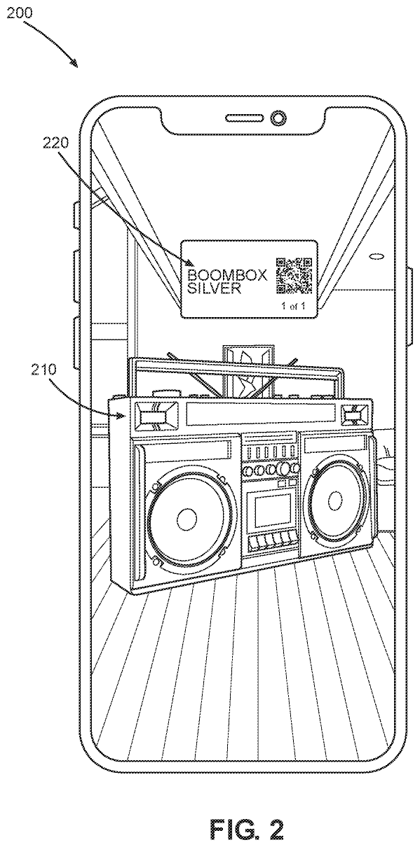

FIG. 2 is a screen shot 200 illustrating an example digital object 210 and corresponding blockchain-certified digital object metadata represented within an augmented reality (AR) presentation medium, in accordance with embodiments. As illustrated, the blockchain-certified digital object metadata is rendered as a certificate object 220. Certificate object 220 includes the digital object author information, current owner information, edition information, and a resource locator for accessing an origin point (e.g., marketplace of) digital object 210.

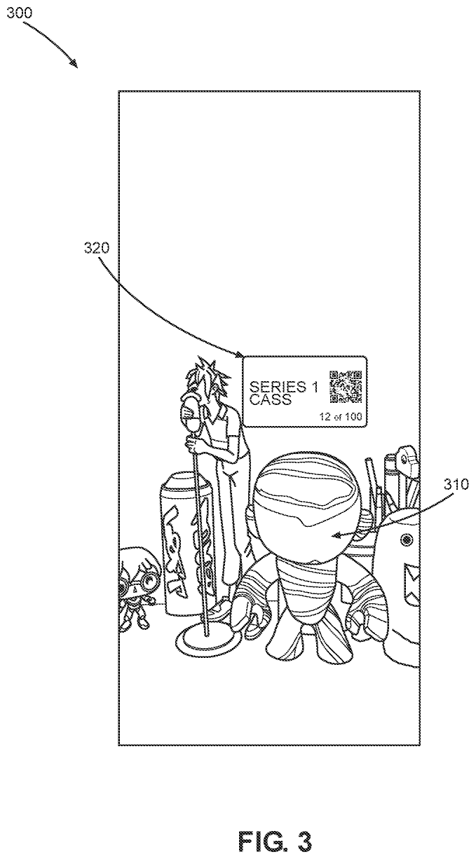

FIG. 3 is a screen shot 300 illustrating an example digital object and corresponding blockchain-certified digital object metadata represented within a virtual three-dimensional space presentation medium, in accordance with embodiments. As illustrated, the blockchain-certified digital object metadata is rendered as a certificate object 320. Certificate object 320 includes the digital object author information, current owner information, edition information, and a resource locator for accessing an origin point (e.g., marketplace of) digital object 310.

### Example Computer System

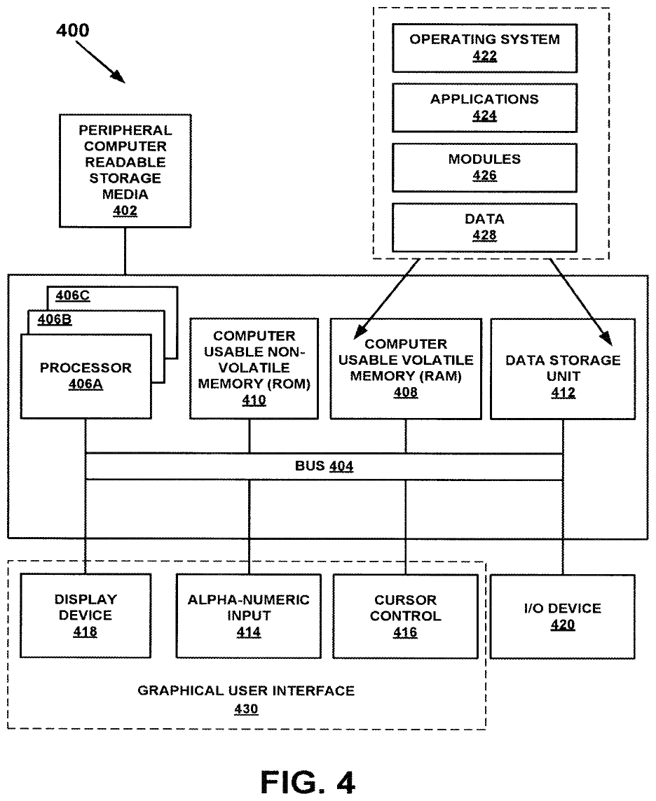

FIG. 4 is a block diagram of an example computer system 400 upon which embodiments of the present invention can be implemented. FIG. 4 illustrates one example of a type of computer system 400 (e.g., a computer system) that can be used in accordance with or to implement various embodiments which are discussed herein.

It is appreciated that computer system 400 of FIG. 4 is only an example and that embodiments as described herein can operate on or within a number of different computer systems including, but not limited to, general purpose networked computer systems, embedded computer systems, mobile electronic devices, smart phones, server devices, client devices, various intermediate devices/nodes, standalone computer systems, media centers, handheld computer systems, multi-media devices, and the like. In some embodiments, computer system 400 of FIG. 4 is well adapted to having peripheral tangible computer-readable storage media 402 such as, for example, an electronic flash memory data storage device, a floppy disc, a compact disc, digital versatile disc, other disc based storage, universal serial bus “thumb” drive, removable memory card, and the like coupled thereto. The tangible computer-readable storage media is non-transitory in nature.

Computer system 400 of FIG. 4 includes an address/data bus 404 for communicating information, and a processor 406A coupled with bus 404 for processing information and instructions. As depicted in FIG. 4, computer system 400 is also well suited to a multi-processor environment in which a plurality of processors 406A, 406B, and 406C are present. Conversely, computer system 400 is also well suited to having a single processor such as, for example, processor 406A. Processors 406A, 406B, and 406C may be any of various types of microprocessors. Computer system 400 also includes data storage features such as a computer usable volatile memory 408, e.g., random access memory (RAM), coupled with bus 404 for storing information and instructions for processors 406A, 406B, and 406C. Computer system 400 also includes computer usable non-volatile memory 410, e.g., read only memory (ROM), coupled with bus 404 for storing static information and instructions for processors 406A, 406B, and 406C. Also present in computer system 400 is a data storage unit 412 (e.g., a magnetic or optical disc and disc drive) coupled with bus 404 for storing information and instructions. Computer system 400 also includes an alphanumeric input device 414 including alphanumeric and function keys coupled with bus 404 for communicating information and command selections to processor 406A or processors 406A, 406B, and 406C. Computer system 400 also includes a cursor control device 416 coupled with bus 404 for communicating user input information and command selections to processor 406A or processors 406A, 406B, and 406C. In one embodiment, computer system 400 also includes a display device 418 coupled with bus 404 for displaying information.

Referring still to FIG. 4, display device 418 of FIG. 4 may be a liquid crystal device (LCD), light emitting diode display (LED) device, cathode ray tube (CRT), plasma display device, a touch screen device, or other display device suitable for creating graphic images and alphanumeric characters recognizable to a user. Cursor control device 416 allows the computer user to dynamically signal the movement of a visible symbol (cursor) on a display screen of display device 418 and indicate user selections of selectable items displayed on display device 418. Many implementations of cursor control device 416 are known in the art including a trackball, mouse, touch pad, touch screen, joystick or special keys on alphanumeric input device 414 capable of signaling movement of a given direction or manner of displacement. Alternatively, it will be appreciated that a cursor can be directed and/or activated via input from alphanumeric input device 414 using special keys and key sequence commands. Computer system 400 is also well suited to having a cursor directed by other means such as, for example, voice commands. In various embodiments, alphanumeric input device 414, cursor control device 416, and display device 418, or any combination thereof (e.g., user interface selection devices), may collectively operate to provide a graphical user interface (GUI) 430 under the direction of a processor (e.g., processor 406A or processors 406A, 406B, and 406C). GUI 430 allows user to interact with computer system 400 through graphical representations presented on display device 418 by interacting with alphanumeric input device 414 and/or cursor control device 416.

Computer system 400 also includes an I/O device 420 for coupling computer system 400 with external entities. For example, in one embodiment, I/O device 420 is a modem for enabling wired or wireless communications between computer system 400 and an external network such as, but not limited to, the Internet. In one embodiment, I/O device 420 includes a transmitter. Computer system 400 may communicate with a network by transmitting data via I/O device 420.

Referring still to FIG. 4, various other components are depicted for computer system 400. Specifically, when present, an operating system 422, applications 424, modules 426, and data 428 are shown as typically residing in one or some combination of computer usable volatile memory 408 (e.g., RAM), computer usable non-volatile memory 410 (e.g., ROM), and data storage unit 412. In some embodiments, all or portions of various embodiments described herein are stored, for example, as an application 424 and/or module 426 in memory locations within RAM 408, computer-readable storage media within data storage unit 412, peripheral computer-readable storage media 402, and/or other tangible computer-readable storage media.

### Example Mobile Electronic Device

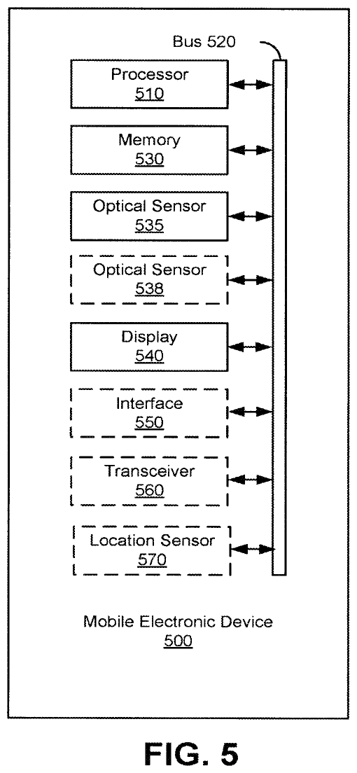

FIG. 5 is a block diagram of an example mobile electronic device 500 upon which embodiments of the present invention can be implemented. As will be appreciated, mobile electronic device 500 may be implemented as a device or apparatus, such as a handheld mobile electronic device, that can be moved in space by a human user. That is, mobile electronic device 500 is small enough to be held in the hand of a human user, in various embodiments. For example, such a mobile electronic device may be, without limitation, a mobile telephone phone (e.g., smartphone, cellular phone, a cordless phone running on a local network, or any other cordless telephone handset), a wired telephone (e.g., a phone attached by a wire), a personal digital assistant (PDA), a video game player, video game controller, a navigation device, an activity or fitness tracker device (e.g., bracelet, clip, band, or pendant), a smart watch or other wearable device, a mobile internet device (MID), a personal navigation device (PND), a digital still camera, a digital video camera, a portable music player, a portable video player, a portable multi-media player, a remote control, a headset, or a combination of one or more of these devices.

As depicted in FIG. 5, mobile electronic device 500 may include a processor 510, a bus 520, a memory 530, at least one optical sensor 535, and a display 540. Some embodiments of mobile electronic device 500 may further include one or more of an interface 550, a transceiver 560 (all depicted in dashed lines), a location sensor 570, and/or other components. In various embodiments, electrical power for mobile electronic device 500 is provided by a mobile power source such as a battery, when not being actively charged.

Processor 510 can be one or more microprocessors, central processing units (CPUs), DSPs, general purpose microprocessors, ASICs, ASIPs, FPGAs or other processors which run software programs or applications, which may be stored in memory 530, associated with the functions and capabilities of mobile electronic device 500.

Bus 520 may be any suitable bus or interface to include, without limitation, a peripheral component interconnect express (PCIe) bus, a universal serial bus (USB), a universal asynchronous receiver/transmitter (UART) serial bus, a suitable advanced microcontroller bus architecture (AMBA) interface, an Inter-Integrated Circuit (I2C) bus, a serial digital input output (SDIO) bus, a serial peripheral interface (SPI) or other equivalent. In the embodiment shown, processor 510, memory 530, display 540, interface 550, transceiver 560, and other components of mobile electronic device 500 may be coupled communicatively through bus 520 in order to exchange commands and data. Depending on the architecture, different bus configurations may be employed as desired. For example, additional buses may be used to couple the various components of mobile electronic device 500, such as by using a dedicated bus between processor 510 and memory 530.

Memory 530 can be any suitable type of memory, including but not limited to electronic memory (e.g., read only memory (ROM), random access memory, or other electronic memory), hard disk, optical disk, or some combination thereof. Multiple layers of software can be stored in memory 530 for use with/operation upon processor 510. For example, an operating system layer can be provided for mobile electronic device 500 to control and manage system resources in real time, enable functions of application software and other layers, and interface application programs with other software and functions of mobile electronic device 500. Similarly, a user experience system layer may operate upon or be facilitated by the operating system. The user experience system may comprise one or more software application programs such as menu navigation software, games, device function control, gesture recognition, image processing or adjusting, voice recognition, navigation software, communications software (such as telephony or wireless local area network (WLAN) software), and/or any of a wide variety of other software and functional interfaces for interaction with the user can be provided. In some embodiments, multiple different applications can be provided on a single mobile electronic device 500, and in some of those embodiments, multiple applications can run simultaneously as part of the user experience system. In some embodiments, the user experience system, operating system, and/or the processor 510 may operate in a low-power mode (e.g., a sleep mode) where very few instructions are processed. Such a low-power mode may utilize only a small fraction of the processing power of a full-power mode (e.g., an awake mode) of the processor 510.

Optical sensor 535 may comprise, without limitation: a video capture device, a camera, and infrared camera, or other type of optical sensor for capturing a video of a person, an object, and/or a scene. It should be appreciated that mobile electronic device 500 may include more than one optical sensor. In one example, optical sensor 535 is a back-side optical sensor (e.g., rear-facing camera) and optical sensor 538 is a front-side optical sensor (e.g., front-facing camera).

Display 540, may be a liquid crystal device, (organic) light emitting diode device, or other display device suitable for creating and visibly depicting graphic images and/or alphanumeric characters recognizable to a user. Display 540 may be configured to output images viewable by the user and may additionally or alternatively function as a viewfinder for camera. Display 540 is configured to display video captured at optical sensor 535 (and optical sensor 538, when included).

Interface 550, when included, can be any of a variety of different devices providing input and/or output to a user, such as audio speakers, touch screen integrated with display 540, real or virtual buttons, joystick, slider, knob, printer, scanner, computer network I/O device, other connected peripherals and the like.

Transceiver 560, when included, may be one or more of a wired or wireless transceiver which facilitates receipt of data at mobile electronic device 500 from an external transmission source and transmission of data from mobile electronic device 500 to an external recipient. By way of example, and not of limitation, in various embodiments, transceiver 560 comprises one or more of: a cellular transceiver, a wireless local area network transceiver (e.g., a transceiver compliant with one or more Institute of Electrical and Electronics Engineers (IEEE) 802.11 specifications for wireless local area network communication), a wireless personal area network transceiver (e.g., a transceiver compliant with one or more IEEE 802.15 specifications for wireless personal area network communication), and a wired a serial transceiver (e.g., a universal serial bus for wired communication).

Location sensor 570, when included, may be a sensor for determining a location of mobile electronic device 500, such as a navigation satellite system sensor such as a Global Navigation Satellite System (GNSS) receiver (e.g., Global Positioning System (GPS) sensor) a and/or other component configured to determine the location of mobile electronic device 500 from external radio signals. It is noted that the functionality of location sensor 570 may be implemented by processor 510.

### Example Methods of Operation

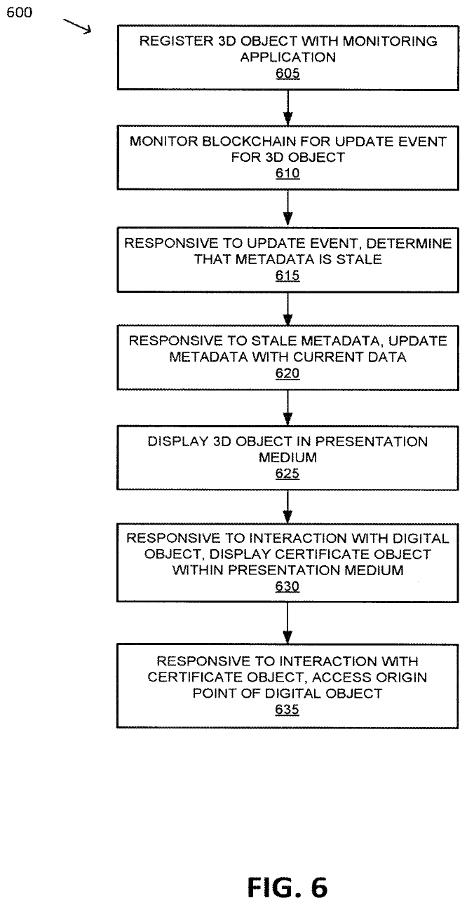

The following discussion sets forth in detail the operation of some example methods of operation of embodiments. With reference to FIG. 6, flow diagram 600 illustrates example procedures used by various embodiments. The flow diagrams include some procedures that, in various embodiments, are carried out by a processor under the control of computer-readable and computer-executable instructions. In this fashion, procedures described herein and in conjunction with the flow diagrams are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments (e.g., computer system 400 and/or mobile electronic device 500). The computer-readable and computer-executable instructions, which reside on tangible computer readable storage media, are used to control or operate in conjunction with, for example, one or some combination of processors of the computer environments and/or virtualized environment. It is appreciated that the processor(s) may be physical or virtual or some combination (it should also be appreciated that a virtual processor is implemented on physical hardware). Although specific procedures are disclosed in the flow diagram, such procedures are examples. That is, embodiments are well suited to performing various other procedures or variations of the procedures recited in the flow diagram. Likewise, in some embodiments, the procedures in the flow diagrams may be performed in an order different than presented and/or not all of the procedures described in the flow diagrams may be performed. It is further appreciated that procedures described in the flow diagrams may be implemented in hardware, or a combination of hardware with firmware and/or software provided by computer system 400 and/or mobile electronic device 500.

FIG. 6 is a flow diagram 600 of example operations for displaying blockchain data associated with a three-dimensional digital object, according to various embodiments.

At procedure 605 of flow diagram 600, a three-dimensional digital object is registered with an application for monitoring blockchain events corresponding to a transfer event for the three-dimensional digital object, wherein the three-dimensional digital object has corresponding metadata comprising ownership information of the three-dimensional digital object. In some embodiments, the metadata further includes at least one of: authorship identification, a blockchain address, a title, an edition number, a resource locator for linking to an origin point, attributes of the NFT, and three-dimensional coordinates of voxels.

At procedure 610, the blockchain events are monitored for events corresponding to an update event (e.g., a transfer event) for the three-dimensional digital object. At procedure 615, responsive to detecting an update event for the three-dimensional digital object, it is determined that the metadata for the three-dimensional digital object comprises stale data. At procedure 620, responsive to determining that the metadata for the three-dimensional digital object is stale, the metadata is updated to replace the stale data with current data. In some embodiments, where the update event is a transfer event, the metadata is updated such that at least the ownership information is updated.

At procedure 625, the three-dimensional digital object is displayed within a presentation medium. In some embodiments, the presentation medium includes one of an augmented reality medium and a virtual three-dimensional medium. At procedure 630, responsive to detecting a first interaction with the three-dimensional digital object within the presentation medium, a certificate object is displayed within the presentation medium, the certificate object including the current data. In some embodiments, as shown at procedure 635, the method further includes accessing a resource associated with the resource locator for displaying the origin point responsive to detecting a second interaction with resource locator for linking to an origin point of the certificate object within the presentation medium.

In some embodiments, the three-dimensional digital object is comprised of a monolithic data format. In some embodiments, the updating the metadata to replace the stale data with current data includes generating the certificate object using the metadata comprising the current data. The certificate object is stored for retrieval. In some embodiments, displaying a certificate object within the presentation medium includes retrieving the certificate object.

In some embodiments, the three-dimensional digital object is comprised of a dynamic data format. In some embodiments, the updating the metadata to replace the stale data with current data includes storing the metadata comprising the current data. In some embodiments, the displaying a certificate object within the presentation medium includes retrieving the metadata comprising the current data. A certificate object template is displayed within the presentation medium. The certificate object template is populated with the metadata including the current data.

It is noted that any of the procedures stated above, regarding the flow diagram of FIG. 6, may be implemented in hardware, or a combination of hardware with firmware and/or software. For example, any of the procedures are implemented by a processor(s) of a cloud environment and/or a computing environment.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Many variations, modifications, additions, and improvements are possible, regardless the degree of virtualization. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

What is claimed is:

1. A computer-implemented method for displaying blockchain data associated with a three-dimensional digital object, the method comprising:
registering a three-dimensional digital object with an application for monitoring blockchain events corresponding to an update event for the three-dimensional digital object, wherein the three-dimensional digital object has corresponding metadata;
monitoring the blockchain events for an event corresponding to the update event for the three-dimensional digital object;
responsive to detecting the update event for the three-dimensional digital object, determining that the metadata for the three-dimensional digital object comprises stale data;
responsive to determining that the metadata for the three-dimensional digital object comprises the stale data, updating the metadata to replace the stale data with current data such that at least some of the metadata is updated;
displaying the three-dimensional digital object within a presentation medium; and
responsive to detecting a first interaction with the three-dimensional digital object within the presentation medium, displaying a certificate object within the presentation medium, the certificate object comprising the current data.

2. The method of claim 1, wherein the three-dimensional digital object is comprised of a monolithic data format.

3. The method of claim 2, wherein the updating the metadata to replace the stale data with current data comprises:
generating the certificate object using the metadata comprising the current data; and
storing the certificate object for retrieval.

4. The method of claim 3, wherein the displaying a certificate object within the presentation medium comprises:
retrieving the certificate object.

5. The method of claim 1, wherein the three-dimensional digital object is comprised of a dynamic data format.

6. The method of claim 5, wherein the updating the metadata to replace the stale data with current data comprises:
storing the metadata comprising the current data.

7. The method of claim 6, wherein the displaying a certificate object within the presentation medium comprises:
retrieving the metadata comprising the current data;
displaying a certificate object template within the presentation medium; and
populating the certificate object template with the metadata comprising the current data.

8. The method of claim 1, wherein the presentation medium comprises one of an augmented reality medium and a virtual three-dimensional medium.

9. The method of claim 1, wherein the metadata further comprises at least ownership information;
authorship identification;
a blockchain address;
a title;
an edition number;
attribute information for rendering the three-dimensional digital object; and
a resource locator for linking to an origin point.

10. The method of claim 1, further comprising:
responsive to detecting a second interaction with resource locator for linking to an origin point of the certificate object within the presentation medium, accessing a resource associated with the resource locator for displaying the origin point.

11. The method of claim 1, wherein the update event comprises a transfer event indicating a transfer of ownership of the three-dimensional digital object.

12. The method of claim 11, wherein the updating the metadata to replace the stale data with current data such comprises:
updating the metadata to replace the stale data with current data such that at least ownership information is updated.

13. A non-transitory computer readable storage medium having computer readable program code stored thereon for causing a computer system to perform a method for displaying blockchain data associated with a three-dimensional digital object, the method comprising:
registering a three-dimensional digital object with an application for monitoring blockchain events corresponding to a transfer event for the three-dimensional digital object, wherein the three-dimensional digital object has corresponding metadata comprising ownership information of the three-dimensional digital object;
monitoring the blockchain events for an event corresponding to a transfer event for the three-dimensional digital object;
responsive to detecting the transfer event for the three-dimensional digital object, determining that the metadata for the three-dimensional digital object comprises stale data;
responsive to determining that the metadata for the three-dimensional digital object comprises the stale data, updating the metadata to replace the stale data with current data such that at least the ownership information is updated;
displaying the three-dimensional digital object within a presentation medium; and
responsive to detecting a first interaction with the three-dimensional digital object within the presentation medium, displaying a certificate object within the presentation medium, the certificate object comprising the current data.

14. The non-transitory computer readable storage medium of claim 13, wherein the three-dimensional digital object is comprised of a monolithic data format.

15. The non-transitory computer readable storage medium of claim 14, wherein the updating the metadata to replace the stale data with current data comprises:
generating the certificate object using the metadata comprising the current data; and
storing the certificate object for retrieval.

16. The non-transitory computer readable storage medium of claim 15, wherein the displaying a certificate object within the presentation medium comprises:
retrieving the certificate object.

17. The non-transitory computer readable storage medium of claim 13, wherein the three-dimensional digital object is comprised of a dynamic data format.

18. The non-transitory computer readable storage medium of claim 17, wherein the updating the metadata to replace the stale data with current data comprises:
storing the metadata comprising the current data.

19. The non-transitory computer readable storage medium of claim 18, wherein the displaying a certificate object within the presentation medium comprises:
retrieving the metadata comprising the current data;
displaying a certificate object template within the presentation medium; and
populating the certificate object template with the metadata comprising the current data.

20. The non-transitory computer readable storage medium of claim 13, wherein the metadata further comprises at least one of:
authorship identification;
a blockchain address;
a title;
an edition number;
attribute information for rendering the three-dimensional digital object; and
a resource locator for linking to an origin point.
